(19) United States
(12) Patent Application Publication
(10) Pub. No.: US 2015/0029393 A1
(43) Pub. Date: Jan. 29, 2015

(54) IMAGE PROCESSING APPARATUS AND STORAGE MEDIUM

(71) Applicant: SONY CORPORATION, Tokyo (JP)

(72) Inventors: TSUBASA TSUKAHARA, Tokyo (JP); DAISUKE NAGANO, Kanagawa (JP); DAISUKE SATO, Tokyo (JP)

(21) Appl. No.: 14/331,521

(22) Filed: Jul. 15, 2014

(30) Foreign Application Priority Data
Jul. 24, 2013 (JP) 2013-153525

(51) Int. Cl. H04N 7/01

(52) U.S. Cl. CPC H04N 7/0122
USPC 348/445

(57) ABSTRACT

There is provided an image processing apparatus including an image generation section which generates a compressed image with a second aspect ratio having a short side smaller than that of a first aspect ratio based on pixel values from an imaging section which performs imaging with the first aspect ratio.

### CROSS REFERENCE TO RELATED APPLICATIONS

This application claims the benefit of Japanese Priority Patent Application JP 2013-153525 filed Jul. 24, 2013, the entire contents of which are incorporated herein by reference.

### BACKGROUND

The present disclosure relates to an image processing apparatus and a storage medium.

In recent years, high-definition television systems with horizontally long screens, called HDTVs (High Definition Televisions), have become widespread. While an aspect ratio is 4:3 in television systems of related art, an aspect ratio is 16:9 in HDTVs, and is horizontally longer than that of television systems of related art. Further, in recent years even larger display devices, which do not have aspect ratios of 4:3 or 16:9, have become widespread. In such a background, there has been an increase in the chance that content will be reproduced by a display device which has an aspect ratio different to an aspect ratio of 4:3, which is generally that of related art. Hereinafter, an aspect ratio of 4:3 will be called a standard aspect ratio.

On the other hand, imaging apparatuses such as digital still cameras, video cameras and mobile phones capture a still image or a moving image with a standard aspect ratio the same as that of television systems of related art, and image sensors used by these imaging apparatuses also have a standard aspect ratio. Accordingly, technology has been developed which outputs an image different to that of a standard aspect ratio, by using an image sensor of related art which has a standard aspect ratio.

For example, JP 2006-217214A discloses technology which displays a part of an image with an aspect ratio of 4:3 or the like with a horizontally long aspect ratio such as 16:9.

### SUMMARY

However, in the technology disclosed in JP 2006-217214A, an image with an aspect ratio to be output is generated, by cutting out regions from within a captured image which are not included in the aspect ratio of the image to be output. Accordingly, there is a problem in which the image will appear narrow, by the amount which an aspect ratio of an image sensor and an aspect ratio of an image to be output are different.

Accordingly, the present disclosure proposes a new and improved image processing apparatus and storage medium capable of making an image appear wider, even in the case where an aspect ratio of an image sensor and an aspect ratio of an image to be output are different.

According to the present disclosure, an image processing apparatus is provided, including an image generation section which generates a compressed image with a second aspect ratio having a short side smaller than that of a first aspect ratio, based on pixel values from an imaging section which performs imaging with the first aspect ratio.

Further, according to the present disclosure, a non-transitory computer-readable storage medium having a program stored therein is provided, which causes a computer to function as an image generation section which generates a compressed image with a second aspect ratio having a short side smaller than that of a first aspect ratio, based on pixel values from an imaging section which performs imaging with the first aspect ratio.

According to the present disclosure such as described above, it is possible to make an image appear wider, even in the case where an aspect ratio of an image sensor and an aspect ratio of an image to be output are different.

### BRIEF DESCRIPTION OF THE DRAWINGS

FIG. 1A and FIG. 1B are figures for describing an outline of an image process according to an embodiment of the present disclosure;

FIG. 2A, FIG. 2B, and FIG. 2C are figures for describing an image process according to a first comparative example;

FIG. 3A, FIG. 3B, and FIG. 3C are figures for describing an image process according to a second comparative example;

FIG. 4 is a block diagram which shows a configuration of an image processing apparatus according to an embodiment of the present disclosure;

FIG. 5A, FIG. 5B, and FIG. 5C are figures for describing an image process according to a first embodiment of the present disclosure;

FIG. 6A, FIG. 6B, and FIG. 6C are figures for describing an image process according to a second embodiment of the present disclosure;

FIG. 7 is a flow chart which shows the operations of the image processing apparatus according to the second embodiment; and

FIG. 8 is a figure which shows a hardware configuration example of the image processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order:

1. Outline of the image process according to an embodiment of the present

### DISCLOSURE

2. The embodiments

2-1. Functional configuration

2-2. The first embodiment

2-3. The second embodiment

2-4. Reference embodiment

2-5. Hardware configuration

3. Conclusion

### 1. Outline of the Image Process According to an Embodiment of the Present Disclosure

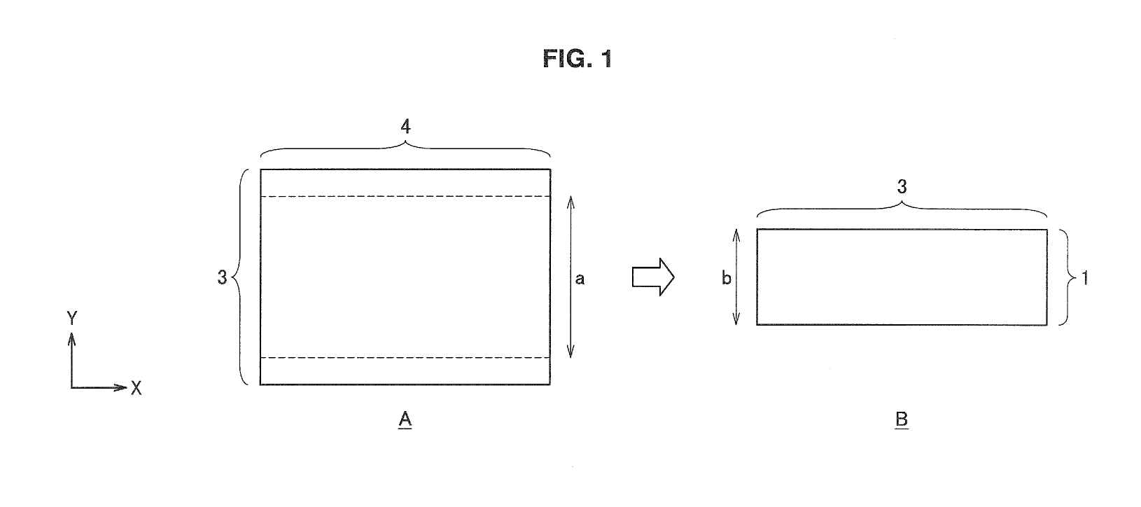

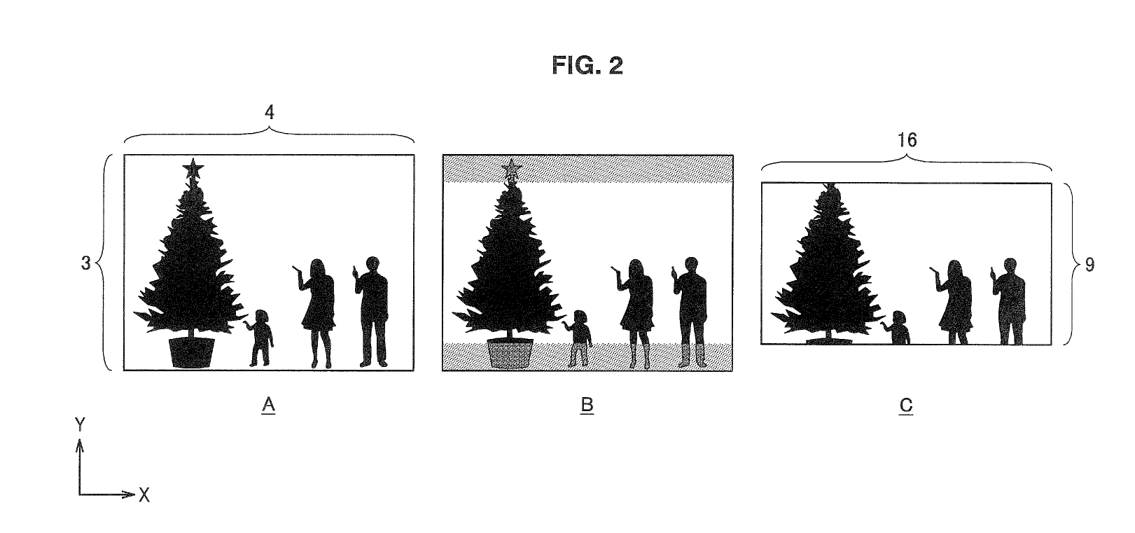

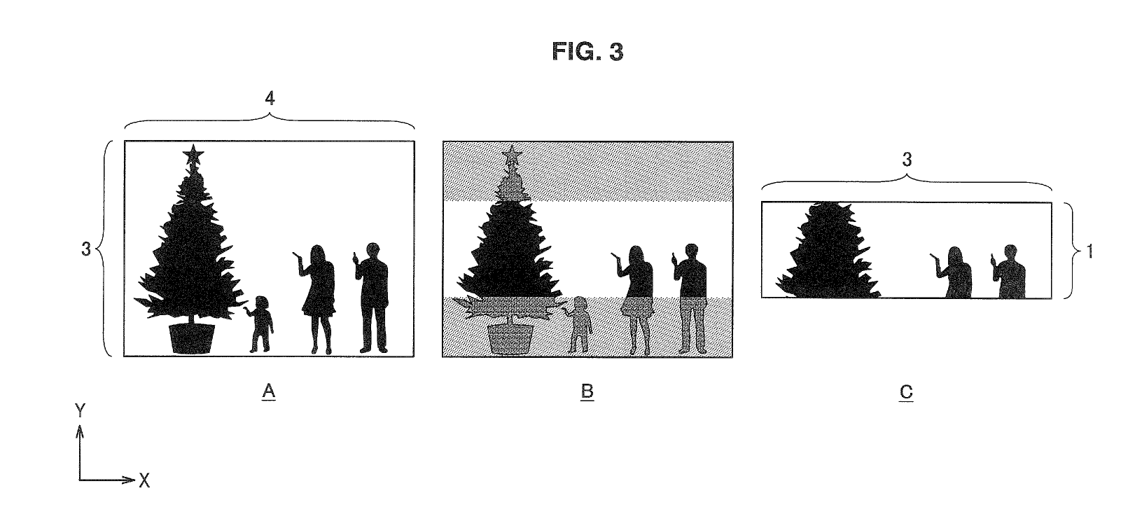

First, an outline of an image process according to an embodiment of the present disclosure will be described with reference to FIG. 1A, FIG. 1B, FIG. 2A, FIG. 2B, FIG. 2C, FIG. 3A, FIG. 3B, and FIG. 3C.

FIG. 1A and FIG. 1B are figures for describing an outline of an image process according to an embodiment of the present disclosure. In more detail, FIG. 1A shows an image captured by an image sensor with a standard aspect ratio, and FIG. 1B shows an image generated by the image process according to an embodiment of the present disclosure. Note that, the image shown in FIG. 1A and the image shown in FIG. 1B have the same length in the X-axis direction, and only have different lengths in the Y-axis direction. As shown in FIG. 1A and FIG. 1B, in the image process according to an embodiment of the present disclosure, an image is generated, from an image with a standard aspect ratio, with an aspect ratio horizontally longer than that of a standard aspect ratio. Hereinafter, an aspect ratio horizontally longer than that of a standard aspect ratio will be called a horizontally long aspect ratio. While an aspect ratio of the image is set as 3:1 (27:9) in FIG. 1B as an example, it may be another horizontally long aspect ratio such as 16:9, 21:9, 24:9. 32:9 or 36:9.

Here, in recent years, there has been an increase in the chance that content will be reproduced by a display device which has an aspect ratio different to a standard aspect ratio. However, a large investment, such as changing existing equipment, may be necessary in the manufacture of an image sensor different to that of a standard aspect ratio. Further, since there will be cases of the availability, cost and size of image sensors in addition to capturing images with a standard aspect ratio in an imaging apparatus, an image sensor with a standard aspect ratio is generally used. Accordingly, technology has been sought after which captures an image with a desired aspect ratio, without changing the aspect ratio of an image sensor.

In such an imaging apparatus which captures an image with a horizontally long aspect ratio by using an image sensor with a standard aspect ratio, an image with a horizontally long aspect ratio is generated and output, by cutting out upper and lower regions within an original image with an aspect ratio of 4:3 captured by the image sensor. Accordingly, there is a problem in which parts of a photographic subject captured by the image sensor are not reflected in the output image. This problem will be specifically described with reference to FIG. 2A, FIG. 2B, and FIG. 2C and FIG. 3A, FIG. 3B, and FIG. 3C.

FIG. 2A, FIG. 2B, and FIG. 2C are figures for describing an image process according to a first comparative example. In more detail, FIG. 2A shows an image captured by an image sensor with a standard aspect ratio, FIG. 2B shows regions cut out in the image process according to the present comparative example, and FIG. 2C shows an image output by the image process according to the present comparative example. The images shown in FIG. 2A, FIG. 2B and FIG. 2C have the same length in the X-axis direction. The image process according to the present comparative example obtains the image with an aspect ratio of 16:9 shown in FIG. 2C, from the image with an aspect ratio of 4:3 (16:12) shown in FIG. 2A, by removing regions of the upper and lower end parts of the image shown in FIG. 2B. For example, in the case of a display of 16:9, a user determines the composition while viewing the image shown in FIG. 2C as a through image, and the image sensor captures the image of FIG. 1A. To continue, a comparative example, in which an image of 3:1 is generated by an image sensor with a standard aspect ratio, will be described with reference to FIG. 3A, FIG. 3B, and FIG. 3C.

FIG. 3A, FIG. 3B, and FIG. 3C are figures for describing an image process according to a second comparative example. In more detail, FIG. 3A shows an image captured by an image sensor with a standard aspect ratio, FIG. 3B shows regions cut out in the image process according to the present comparative example, and FIG. 3C shows an image output by the image process according to the present comparative example. The images shown in FIGS. 3A, 3B and 3C have the same length in the X-axis direction. The image process according to the present comparative example obtains the image with an aspect ratio of 3:1 (12:4) shown in FIG. 3C, from the image with an aspect ratio of 4:3 (12:9) shown in FIG. 3A, by removing regions of the upper and lower end parts of the image shown in FIG. 3B.

In this way, since regions of the upper and lower end parts of an image captured by the image sensor with a standard aspect ratio are removed, in the case where an image is generated with a horizontally long aspect ratio such as 16:9 or 3:1 by the image process according to the comparative examples, parts of a photographic subject captured by the image sensor will not be reflected in an output image. Accordingly, there will be cases in which the viewing angle of the Y-axis direction which is the short side direction, that is, the vertical viewing angle, will become narrow. For example, in the case of performing imaging with a viewing angle of 55° with a standard aspect ratio, the vertical viewing angle will become 42.5° when an image is output with a standard aspect ratio as it is. In contrast to this, the vertical viewing angle will become 32.6° in the case where an image of 16:9 is generated by the image process according to the first comparative example, and the vertical viewing angle will become 19.6° in the case where an image of 3:1 is generated by the image process according to the first comparative example.

Accordingly, focusing on the above described situation has led to creating the image processing apparatus according to each of the embodiments of the present disclosure. The image processing apparatus according to each of the embodiments of the present disclosure can make an image appear wider, even in the case where an aspect ratio of an image sensor and an aspect ratio of an image to be output are different.

Specifically, the image processing apparatus according to an embodiment of the present disclosure outputs an image with an aspect ratio different to that of an image sensor, by compressing parts of an image captured by the image sensor with some aspect ratio. In this way, the image processing apparatus according to the present embodiment can reflect the parts cut out in the related art in the image to be output, and as a result, can make the image appear wider.

As shown in FIG. 1A and FIG. 1B, the image processing apparatus according to the present embodiment generates an image with an aspect ratio of 3:1, from an image captured by an image sensor with a standard aspect ratio. At this time, as shown in FIG. 1A and FIG. 1B, the image processing apparatus according to the present embodiment generates an image (hereinafter, called a compressed image), in which pixel values of a region included in the range of a length a, which is longer than a length b of the Y-axis direction of the image to be output, from within an original image are compressed. That is, the image processing apparatus according to the present embodiment generates a compassed image by using a region of the range of a length a, which is a region outside the range of a length b of the Y-axis direction of the image to be output, from within the originally captured image, which has been cut out in the related art. In this way, since an image is generated by using pixel values in a wider range of the Y-axis direction than that of the comparative examples, the image processing apparatus according to the present embodiment can make the vertical viewing angle appear wider compared to that of the comparative examples.

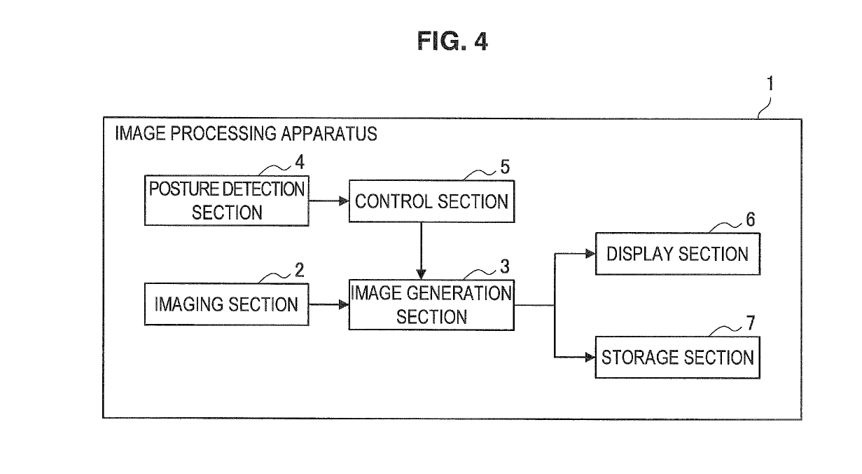

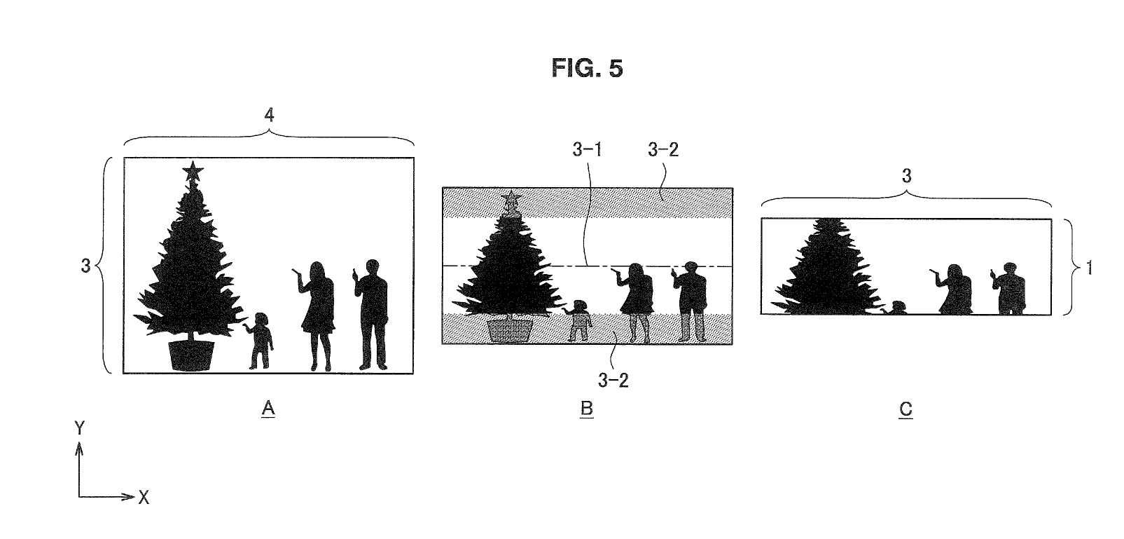

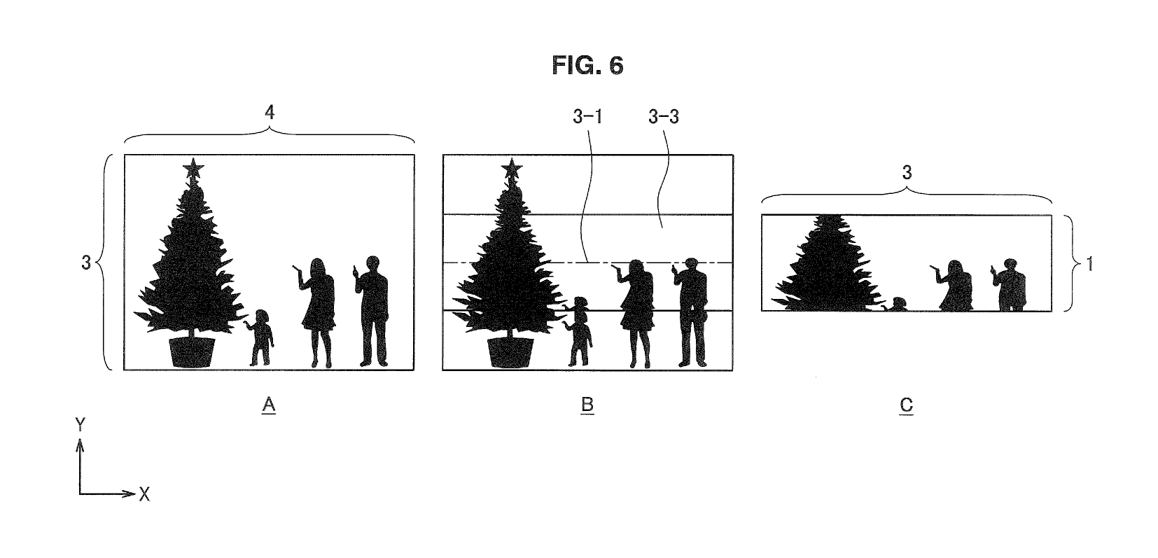

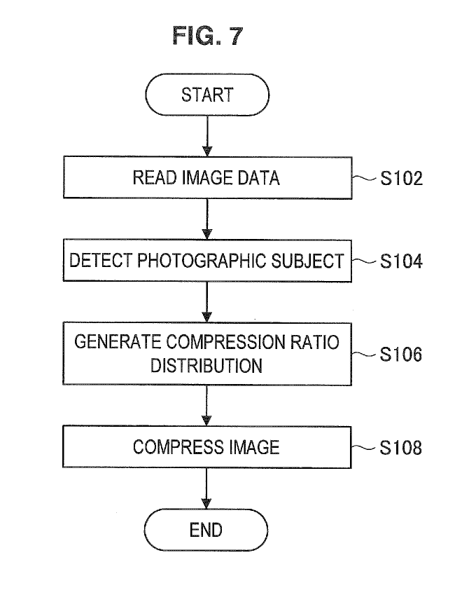

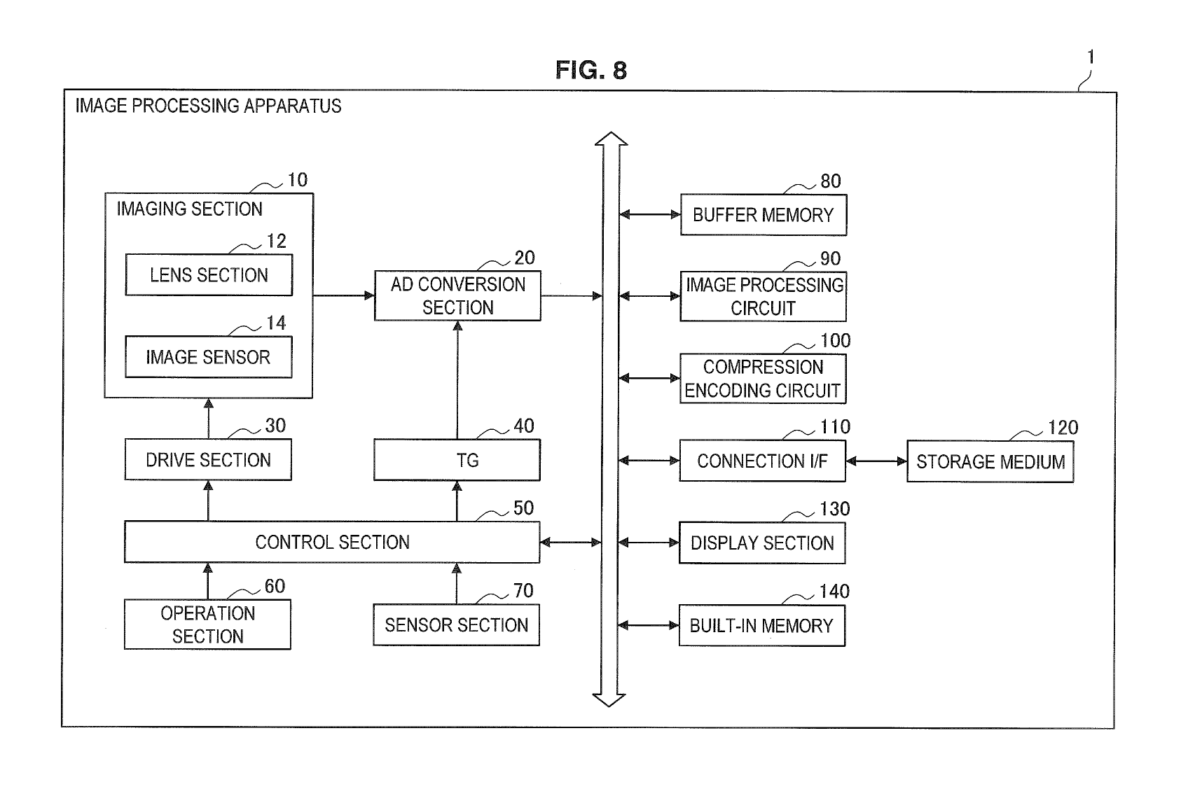

Heretofore, an outline of the image process according to an embodiment of the present disclosure has been described. To continue, each of the embodiments will be specifically described with reference to FIG. 4, FIG. 5A, FIG. 5B, FIG. 5C, FIG. 6A, FIG. 6B, FIG. 6C, FIG. 7 to FIG. 8.

Note that, the image processing apparatus according to an embodiment of the present disclosure is implemented by a digital camera, a digital video camera, a smart phone, an HMD (Head Mounted Display), a headset, a PDA (Personal Digital Assistant), a PC (Personal Computer), a notebook PC, a tablet terminal, a mobile phone terminal, a portable music playback apparatus, a portable video processing apparatus, a portable game machine or the like.

### 2. The Embodiments

First, a functional configuration of an image processing apparatus, which is common to each of the embodiments, will be described. Note that, since a hardware configuration of the image processing apparatus according to the present embodiment will be described in detail afterwards with reference to FIG. 8, a description of this will be omitted here.

### 2-1. Functional Configuration

FIG. 4 is a block diagram which shows a configuration of the image processing apparatus according to an embodiment of the present disclosure. As shown in FIG. 4, the image processing apparatus 1 has an imaging section 2, an image generation section 3, a posture detection section 4, a control section 5, a display section 6, and a storage section 7.

(Imaging Section 2)

The imaging section 2 has a function which captures an image with a first aspect ratio. The imaging section 2 has an image sensor with the first aspect ratio. While the first aspect ratio is capable of taking an arbitrary aspect ratio, it will be assumed to be a standard aspect ratio of 4:3 in the present disclosure. The imaging section 2 outputs pixel values of the captured image to the image generation section 3.

(Image Generation Section 3)

The image generation section 3 has a function which generates a compressed image which has a second aspect ratio having a short side smaller than that of the first aspect ratio. While the second aspect ratio is capable of taking an arbitrary aspect ratio, it will be assumed to be 3:1 (27:9) in the present disclosure. That is, the image generation section 3 generates a compressed image which has a horizontally longer aspect ratio than that of a standard aspect ratio, based on pixel values of an image captured with a standard aspect ratio by the imaging section 2. Since a horizontally long image can satisfy a greater peripheral visual field of a user with an image, compared to an image without this, the sense of realism, sense of panorama and impact will increase. Further, since the viewing angle of a person is wider in the horizontal direction than in the vertical direction, a horizontally long image is said to be closer to the visual field of a person compared to that of an image without this. Accordingly, a horizontally long image can increase the narrative of an image, by providing a sensation such as if those who are viewing it were at the position at which this image has been captured.

Here, as shown in the above described description with reference to FIG. 1, the image generation section 3 generates a compressed image by using pixel values of a range wider in the Y-axis direction than that of the comparative examples, which includes the regions cut out in the comparative examples. Accordingly, the compressed image can make the vertical viewing angle appear wider.

Further, the image generation section 3 compresses the pixel values with a higher compression ratio as they separate from a reference line parallel with a long side of the image shown by the pixel values output from the imaging section 2. In more detail, the image generation section 3 generates a compression ratio distribution, in which a low compression ratio is set for pixels near the reference line and a high compression ratio is set for pixels far from the reference line. Also, the image generation section 3 compresses the pixel values output from the imaging section 2, in accordance with the generated compression ratio distribution. Specifically, the image generation section 3 outputs one pixel based on more pixels adjacent to the short side direction as it separates from the reference line. For example, in the case of pixels near the reference line, the image generation section 3 outputs one pixel as the one pixel as it is. On the other hand, in the case of pixels far from the reference line, the image generation section 3 outputs one pixel, by averaging pixel values of a plurality of pixels adjacent to the short side direction. That is, more compression is performed the more the upper and lower ends of the image sensor of the imaging section 2 are approached. In this way, image deterioration due to compression can be prevented for the region near the reference line, that is, the region to be noticed. Note that, the reference line is a line serving as a standard when the image generation section 3 determines a compression ratio, and is set to an arbitrary position.

Further, the image generation section 3 may generate a compressed image by removing a part of the pixel values output from the imaging section 2. Specifically, the image generation section 3 generates a compressed image based on a part of the pixel values from among the pixel values output from the imaging section 2, and removes the pixel values other than these. The pixel values removed at this time are pixel values of the regions of both end parts of the short side direction separated from the reference line. In this way, unreasonable compression can be prevented at both end parts of the short side direction, and both end parts of the short side direction of the compressed image can be made to appear more naturally.

The image generation section 3 outputs the generated compressed image to the display section 6 and the storage section 7.

(Posture Detection Section 4)

The posture detection section 4 has a function which detects the posture of the display section 6, by detecting the posture of the image processing apparatus 1. Specifically, the posture detection section 4 detects the angle which the long side and the short side of the display section 6 have with respect to the ground. Since the long side direction and the short side direction of the display section 6 each match the long side direction and the short side direction of a captured image captured by the imaging section 2, the posture detection section 4 can perform capturing when detecting the posture of the imaging section 2. The posture detection section 4 outputs information which shows the detected posture of the display section 6 to the control section 5.

(Control Section 5)

The control section 5 has a function which controls whether or not a compressed image is to be generated by the image generation section 3, based on the posture of the display section 6 detected by the posture detection section 4. Specifically, the control section 5 executes the generation of a compressed image in the case where an image with a horizontally long aspect ratio is captured, and stops the generation of a compressed image in the case where an image with a vertically long aspect ratio is captured, based on the orientation of the long side or the short side of the display section 6.

For example, in the case where the orientation of the long side of the display section 6 is in the horizontal direction, the control section 5 causes a compressed image to be generated by the image generation section 3. In this case, an image wider in the horizontal direction is displayed on the display section 6, by performing compression so that the short side of the display section 6, that is, the length of the vertical direction, becomes smaller. On the other hand, in the case where the long side of the display section 6 is in the vertical direction, by having the image processing apparatus 1 set up vertically long by a user, the control section 5 does not causes a compressed image to be generated by the image generation section 3, and causes the image captured by the imaging section 2 to be output to the display section 6 as it is. The reason for this is that, in the case where a compressed image is generated at the time when the orientation of the long side of the display section 6 is in the vertical direction, an unnatural compressed image narrower in the horizontal direction will be displayed on the display section 6, by performing compression so that the short side of the display section 6, that is, the length of the horizontal direction, becomes smaller.

Note that, the control section 5 may switch whether or not a compressed image is to be generated by the image generation section 3, in accordance with a user operation.

(Display Section 6)

The display section 6 has a function which displays image data (still image data/moving image data) output from the image generation section 3. For example, the display section 6 displays a compressed image output in real time from the image generation section 3 during imaging as a so-called through image. In this way, a user can perform operations such as determining a configuration, imaging or various settings, while viewing a through image during imaging by the image processing apparatus 1. The display section 6 may have an aspect ratio of an image that is the second aspect ratio, may be another horizontally long aspect ratio, or may display a compressed image by adding black strips at the top and bottom end parts or the left and right end parts of the screen.

(Storage Section 7)

The storage section 7 has a function which stores the compressed image captured by the imaging section 2 and compressed by the image generation section 3.

Heretofore, a functional configuration of the image processing apparatus 1, which is common to each of the embodiments, has been described. To continue, a first embodiment will be described.

### 2-2. The First Embodiment

The image processing apparatus 1 according to the present embodiment is an embodiment in which a compressed image is generated which makes the vertical viewing angle appear wider, by electrically reducing/compressing parts of a captured image. More specifically, the image generation section 3 according to the present embodiment generates a compressed image, based on pixel values by analog signals (electric charge amounts) output from the imaging section 2. Hereinafter, an image process by the image generation section 3 according to the present embodiment will be described with reference to FIG. 5A, FIG. 5B, and FIG. 5C.

FIG. 5A, FIG. 5B, and FIG. 5C are figures for describing an image process according to a first embodiment. More specifically, FIG. 5A shows a captured image captured by the imaging section 2, FIG. 5B shows an image in which the captured image is compressed and the regions which are to be cut off, and FIG. 5C shows a compressed image output by the image process according to the present embodiment.

First, the image generation section 3 generates the compressed image shown in FIG. 5B, by compressing pixel values output by the imaging section 2. At this time, the image generation section 3 compresses the pixel values with a higher compression ratio as they separate from a reference line 3-1 parallel with the long side of the image shown by the pixel values. Since the image generation section 3 according to the present embodiment performs compression electrically based on pixel values by analog signals, the position of the reference line 3-1 may not be able to be determined based on an image analysis result such as face recognition, which is possible if the signals are digital signals. Accordingly, in the present embodiment, the position of the reference line 3-1 is determined in advance. In the present disclosure, it will be assumed that the reference line 3-1 passes through the center of the image shown by the pixel values. Since it is usually considered that a user is captured by determining a composition such as having the photographic subject positioned at the center, image deterioration due to compression of the photographic subject region to be noticed can be prevented, by performing a setting such as having the reference line 3-1 pass through the center of the image.

Afterwards, the image generation section 3 generates a compressed image by removing both end parts of the short side direction from the image shown by the compressed pixel values. Specifically, the image generation section 3 generates the compressed image with an aspect ratio of 3:1 shown in FIG. 5C, by electrically removing the regions 3-2 of both end parts of the Y-axis direction of the compressed image shown in FIG. 5B. Here, since the compressed image shown in FIG. 5C is an image in which the upper and lower end parts have been removed from the image in which the captured image shown in FIG. 5A has been compressed, pixel values are used with a range wider in the Y-axis direction than when removing the upper and lower end parts without compression. Accordingly, the compressed image shown in FIG. 5C can make the vertical viewing angle appear wider.

In the present embodiment, a user performs imaging, by determining a composition while viewing the compressed image shown in FIG. 5C displayed on the display section 6.

Since the image process according to the present embodiment electrically compresses a captured image and electrically removes the upper and lower regions, it is particularly useful in the case where the calculation capacity of a calculation apparatus such as a CPU (Central Processing Unit) of the image processing apparatus 1 is low.

Heretofore, the first embodiment has been described. To continue, a second embodiment will be described.

### 2-3. The Second Embodiment

The present embodiment is an embodiment in which a compressed image is generated which makes the vertical viewing angle appear wider, by reducing/compressing parts of a captured image by a digital image process, when capturing an image with an aspect ratio different from that of the image sensor. More specifically, the image generation section 3 according to the present embodiment generates a compressed image, based on pixel values by digital signals in which analog signals output from the imaging section 2 have been digitally converted. Hereinafter, an image process by the image generation section 3 according to the present embodiment will be described with reference to FIG. 6A, FIG. 6B, and FIG. 6C.

FIG. 6A, FIG. 6B, and FIG. 6C are figures for describing an image process according to a second embodiment. More specifically, FIG. 6A shows a captured image captured by the imaging section 2, FIG. 6B shows an image in which a part of the captured image is compressed, and FIG. 6C shows a compressed image output by the image process according to the present embodiment.

As shown in FIG. 6B, the image generation section 3 generates the compressed image 3-3 shown in FIG. 6B, by compressing a part of the pixel values output by the imaging section 2. In more detail, first, the image generation section 3 sets the position of the reference line 3-1 and a compression ratio distribution, based on an image analysis result such as face recognition based on pixel values by digital signals. Then, the image generation section 3 generates the compressed image 3-3 in accordance with the compression ratio distribution, based on the pixel values of a part corresponding to the position of the reference line 3-1. Specifically, the image generation section 3 detects a person's face, an animal's face, flowers or the like as a feature portion within the image by face recognition or photographic subject detection, and detects a rectangular region in which the photographic subject is included as a photographic subject region. Next, the image generation section 3 estimates the center of the captured image based on the detected feature portion, determines the position of the reference line 3-1 so as to passes through this center, and determines a compression ratio distribution based on the position/range or the like of the detected photographic subject region. Then, the image generation section 3 generates the compressed image 3-3 with an aspect ratio of 3:1, based on the determined compression ratio distribution. Note that, the position of the reference line 3-1 and the compression ratio distribution may be set by a user operation.

In the present embodiment, a user performs imaging, by determining the composition and apparent vertical angle while viewing the compressed image 3-3 shown in FIG. 6B displayed on the display section 6. As a result of this, as shown in FIG. 6C, the image generation section 3 outputs the compressed image 3-3 shown in FIG. 6B.

Since the compressed image shown in FIG. 6C is an image in which a part of the captured image shown in FIG. 6A has been compressed, pixel values are used with a range wider in the Y-axis direction than when extracting a part of the captured image without compression. Accordingly, the compressed image shown in FIG. 6C can make the vertical viewing angle appear wider.

The image process according to the first embodiment and the image process according to the present embodiment are different for the points of compressing the captured image shown in FIG. 5A, FIG. 5B, and FIG. 5C and then removing unnecessary regions, and compressing a necessary range within the captured image shown in FIG. 6A, FIG. 6B, and FIG. 6C. While it may be necessary for the calculation capacity to be high compared to that of the first embodiment since it is a digital image process, the image process according to the present embodiment can generate a compressed image by a range and compression ratio appropriate for the content of an image, such as a face region or a photographic subject region. Hereinafter, the operation process of the image processing apparatus 1 according to the present embodiment will be described with reference to FIG. 7.

(Operating Processes)

FIG. 7 is a flow chart which shows the operations of the image processing apparatus 1 according to the second embodiment. As shown in FIG. 7, in step S102, the image generation section 3 performs reading of image data. In more detail, the image generation section 3 performs reading of image data captured by the imaging section 2. Note that, the imaging section 2 may hold the captured image data in a buffer memory, and the image generation section 3 may perform reading of the image data from the buffer memory.

Next, in step S104, the image generation section 3 performs detection of a photographic subject. In more detail, the image generation section 3 performs photographic subject detection for the read image data, and sets a rectangular region in which a photographic subject is included as a photographic subject region.

Next, in step S106, the image generation section 3 generates a compression ratio distribution. In more detail, the image generation section 3 obtains central coordinates of the photographic subject region, and generates a compression ratio distribution in which the compression ratio is lowest near to a reference line passing through these central coordinates and the compression ratio increases as it separates from the reference line. Alternatively, the image generation section 3 may perform a face recognition process, and may generate a compression ratio distribution by obtaining central coordinates based on a face recognition result.

Then, in step S108, the image generation section 3 compresses the image. In more detail, the image generation section 3 generates a compressed image by compressing the image data read in step S102, based on the compression ratio distribution generated in step S106.

By the above described processes, the image processing apparatus 1 according to the present embodiment can generates an image in which the vertical viewing angle is made to appear wider, even with a horizontally long aspect ratio such as 16:9 or 3:1. Note that, while central coordinates of the photographic subject region are used in the above description as the center of a compression distribution, coordinates specified by a user may be used as the center of a compression distribution.

Heretofore, the operation process of the image processing apparatus 1 according to the present embodiment has been described.

### 2-4. Reference Embodiment

The present reference embodiment is an embodiment in which an image with a desired aspect ratio is generated, by removing parts of a captured image, when capturing an image with an aspect ratio different to that of the image sensor. The image processing apparatus according to the present reference embodiment outputs an image with a desired horizontally long aspect ratio, by removing regions from a captured image which do not include the image with a desired horizontally long aspect ratio, by an electrical or digital image process.

Since it may not be necessary for the image process according to the present reference embodiment to perform a compression process, the process load is less compared to that of the image processes according to the first and second embodiments. Accordingly, for example, by performing the image process according to the present reference embodiment for a through image, and performing the image process according to the first or second embodiment when performing imaging, the image processing apparatus 1 can output a compressed image with a wider vertical viewing angle while reducing the process load.

### 2-5. Hardware Configuration

Hereinafter, a hardware configuration of the image processing apparatus 1 according to an embodiment of the present disclosure will be described with reference to FIG. 8. Here, as an example, a circuit configuration will be shown in the case where the image processing apparatus 1 is constituted as a digital camera (or, a digital camera section of a mobile phone).

FIG. 8 is a figure which shows a hardware configuration example of the image processing apparatus 1 according to an embodiment of the present disclosure. As shown in FIG. 8, the image processing apparatus 1 has an imaging section 10, an AD (Analog-to-Digital) conversion section 20, a drive section 30, a TG (Timing Generator) 40, a control section 50, an operation section 60, a sensor section 70, a buffer memory 80, an image processing circuit 90, a compression encoding circuit 100, a connection I/F 110, a storage medium 120, a display section 130, and a built-in memory 140.

(Imaging Section 10)

The imaging section 10 has a lens section 12 and an image sensor 14, and functions as the imaging section 2. The lens section 12 is constituted by a plurality of lenses, such as a zoom lens and a focus lens. For example, the image sensor 14 is implemented by a CCD (Charge Coupled Device) or a CMOS (Complementary Metal Oxide Semiconductor), and has a standard aspect ratio of 4:3. The image sensor 14 receives photographic subject light (incident light) captured by the lens section 12, and converts the received light to signal charges. The image sensor 14 outputs voltages based on the converted signal charges as pixel signals of each of the pixels. Note that, signals in which the pixel signals of each of the pixels are compiled become image signals.

(AD Conversion Section 20)

The AD conversion section 20 converts the input analog signals into digital signals. Specifically, the AD conversion section 20 converts the image signals output from the image sensor 14 from analog signals into digital signals, and writes the converted digital signals to the buffer memory 80.

Here, in the first embodiment, the AD conversion section 20 functions as the image generation section 3. That is, in the first embodiment, the AD conversion section 20 generates a compressed image, based on pixel values by analog signals output from the imaging section 10. Afterwards, the AD conversion section 20 digitalizes the compressed image which is constituted of analog signals, and writes the digitalized compressed image to the buffer memory 80.

(Buffer Memory 80)

The buffer memory 80 is a storage region which temporarily stores data. The buffer memory 80 stores image signals digitalized by the AD conversion section 20, or image data generated by the image processing circuit 90, which will be described later.

(Drive Section 30)

The drive section 30 causes each of the lenses of the lens section 12 to move in an optical axis direction, and causes the photographic subject to be focused.

(TG 40)

The TG 40 causes the operation timings of the image sensor 14 and the AD conversion section 20 to be synchronized, by outputting pulse signals to the image sensor 14 and the AD conversion section 20.

(Image Processing Circuit 90)

The image processing circuit 90 performs image processes such as a white balance process, a color interpolation process, a contour compensation process and a step conversion process. Specifically, the image processing circuit 90 generates image data, by performing these image processes for the image signals written to the buffer memory 80. Also, the image processing circuit 90 causes the generated image data to be temporarily stored in the buffer memory 80.

Here, in the second embodiment, the image processing circuit 90 and the control section 50, which will be described later, function as the image generation section 3. That is, in the second embodiment, the image processing circuit 90 generates a compressed image, by compressing digital image signals written to the buffer memory 80, based on a control by the control section 50, which will be described later.

(Compression Encoding Circuit 100)

The compression encoding circuit 100 performs a compression encoding process for image data, which has been temporarily stored in the buffer memory 80, and to which an image process has been completed by the image processing circuit 90. For example, in the case where there is image data based on a moving image, the compression encoding circuit 100 generates encoded data of an Mpeg (Moving Picture Experts Group) form or an H.26L form. The compression encoding circuit 100 adds supplementary information, which includes photographing conditions, photographing date and time, basic information of the camera or the like, to this encoded data, and writes the added supplementary information to the storage medium 120 connected to the connection I/F 110.

(Connection I/F 110)

The connection I/F 110 electrically connects the image processing apparatus 1 and the storage medium 120. In this way, the image processing apparatus 1 can perform writing of data to the storage medium 120, and reading of data stored in the storage medium 120.

(Storage Medium 120)

The storage medium 120 functions as the storage section 7 which stores image data. The storage medium 120 is implemented, for example, by a recording medium such as a flash memory such as a card-type memory, or a DVD (Digital Versatile Disc).

(Display Section 130)

The display section 130 functions as the display section 6 which displays image data. The display section 130 is implemented, for example, by an LCD (Liquid Crystal Display), an OLED (Organic Light-Emitting Diode) or the like. Apart from a through image, a captured image and a compressed image, the display section 130 displays a setting image when performing settings.

(Built-in Memory 140)

The built-in memory 140 has a storage region which stores control programs, various operation parameters or the like used by the control section 50. The built-in memory 140 is implemented by a ROM (Read Only Memory), a RAM (Random Access Memory), a hard disk or the like.

(Control Section 50)

The control section 50 functions as a calculation processing apparatus and a control apparatus, and controls all the operations within the image processing apparatus 1 in accordance with various programs. The control section 50 is implemented, for example, by a CPU or a microprocessor. Note that, the control section 50 may include a ROM which stores programs to be used, calculation parameters or the like, and a RAM which temporarily stores arbitrarily changing parameters or the like. The control section 50 according to an embodiment of the present disclosure controls all the operations within the image processing apparatus 1, by reading and executing control programs stored in the built-in memory 140.

At the time of imaging, the control section 50 executes processes prior to imaging which include an AE process and an AF process. Also, the control section 50 performs imaging by the imaging section 10 or an imaging process such as an image process by the image processing circuit 90, based on these processes prior to imaging.

Further, the control section 50 functions as the control section 5 which controls whether or not a compressed image is to be generated, in accordance with the posture of the display section 130 detected by the sensor section 70.

In the second embodiment, the control section 50 performs image analysis such as face recognition or photographic subject detection. More specifically, the control section 50 performs a face recognition process or a photographic subject process for a through image, or a still image or moving image stored in the buffer memory 80. Next, the control section 50 generates a compression ratio distribution, based on an image analysis result of face recognition, photographic subject detection or the like. Then, the control section 50 generates a compressed image by controlling the image processing circuit 90, based on the generated compression ratio distribution.

The control section 50 controls the AD conversion section 20 or the image processing circuit 90 so as to generate an image with an aspect ratio set by a user. For example, in the case of performing a setting so as to generate an image with a standard aspect ratio of 4:3, the control section 50 controls the AD conversion section 20 or the image processing circuit 90 so as to perform a process for converting the aspect ratio, for the image data captured by the image sensor 14 with a standard aspect ratio. In this way, image data with a standard aspect ratio is displayed on the display section 130, and is stored in the storage medium 120. In the case of performing a setting so as to generate an image with a horizontally long aspect ratio of 16:9, 3:1 or the like, the control section 50 controls the AD conversion section 20 or the image processing circuit 90 so as to generate an image with a horizontally long aspect ratio by the above described image process according to each of the embodiments. In this way, image data in which a wide vertical angle of a horizontally long aspect ratio is reflected is displayed on the display section 130, and is stored in the storage medium 120.

(Operation Section 60)

The operation section 60 accepts imaging instructions and initial settings from a user, settings at the time when imaging or performing reproduction, settings of an aspect ratio of an output image or the like. Alternatively, the operation section 60 may accept an operation which sets whether or not to execute the image process which enlarges the vertical angle described above in the first embodiment or the second embodiment, or sets which image process is to be executed. The operation section 60 is implemented, for example, as buttons, touch sensors, or a touch panel integrally formed with the display section 130.

(Sensor Section 70)

The sensor section 70 functions as the posture detection section 4 which detects the posture of the image processing apparatus 1. The sensor section 70 is implemented by a sensor which detects the gravitational direction such as an acceleration sensor.

Heretofore, a hardware configuration of the image processing apparatus 1 according to an embodiment of the present disclosure has been described.

### 3. Conclusion

As described above, the image processing apparatus 1 according to an embodiment of the present disclosure can make an image appear wider, even if an aspect ratio of an image sensor and an aspect ratio of an image to be output are different. In more detail, by generating a compressed image using pixel values of regions which are not included in the aspect ratio of an image to be output, the image processing apparatus 1 according to an embodiment of the present disclosure can make an image appear wider than when simply removing these regions.

It should be understood by those skilled in the art that various modifications, combinations, sub-combinations and alterations may occur depending on design requirements and other factors insofar as they are within the scope of the appended claims or the equivalents thereof

For example, while in the above described embodiments a compressed image with a horizontally longer aspect ratio than a first aspect ratio is generated, from an image captured by an image sensor with the first aspect ratio, the present disclosure is not limited to such an example. For example, the image processing apparatus 1 may generate a compressed image with a vertically longer aspect ratio than a first aspect ratio, from an image captured by an image sensor with the first aspect ratio. In this case, by generating a compressed image using regions of both end parts of the horizontal direction which are not included in an image with a vertically long aspect ratio, the image processing apparatus 1 can make a horizontal viewing angle appear wider.

Further, a computer program for causing hardware, such as a CPU, ROM and RAM built into an information processing apparatus to exhibit functions the same as each of the elements of the above described image processing apparatus 1 can be created. Further, a storage medium on which this computer program is recorded can also be provided.

Additionally, the present technology may also be configured as below:

(1) An image processing apparatus including:

an image generation section which generates a compressed image with a second aspect ratio having a short side smaller than that of a first aspect ratio based on pixel values from an imaging section which performs imaging with the first aspect ratio.

(2) The image processing apparatus according to (1),

wherein the image generation section compresses the pixel values with a higher compression ratio as they separate from a reference line parallel with a long side of the image shown by the pixel values.

(3) The image processing apparatus according to (2),

wherein the image generation section generates the compressed image by removing a part of the pixel values.

(4) The image processing apparatus according to (2) or (3),

wherein the pixel values are digital signals.

(5) The image processing apparatus according to (4),

wherein the image generation section generates the compressed image based on the pixel values of a part corresponding to a position of the reference line.

(6) The image processing apparatus according to (5),

wherein the image generation section sets a position of the reference line based on the pixel values.

(7) The image processing apparatus according to (2) or (3),

wherein the pixel values are analog signals.

(8) The image processing apparatus according to (7),

wherein, after the pixel values have been compressed, the image generation section generates the compressed image by removing both ends of a short side direction from the image shown by the compressed pixel values.

(9) The image processing apparatus according to (7) or (8),

wherein the reference line passes through a center of the image shown by the pixel values.

(10) The image processing apparatus according to any one of (1) to (9), further including:

a display section;

a posture detection section which detects a posture of the display section; and

a control section which controls whether or not the compressed image is to be generated by the image generation section in accordance with the posture of the display section detected by the posture detection section.

(11) The image processing apparatus according to any one of (1) to (10),

wherein the first aspect ratio is 4:3, and the second aspect ratio is 27:9.

(12) A non-transitory computer-readable storage medium having a program stored therein, the program causing a computer to function as:

an image generation section which generates a compressed image with a second aspect ratio having a short side smaller than that of a first aspect ratio based on pixel values from an imaging section which performs imaging with the first aspect ratio.

What is claimed is:

1. An image processing apparatus comprising:
an image generation section which generates a compressed image with a second aspect ratio having a short side smaller than that of a first aspect ratio based on pixel values from an imaging section which performs imaging with the first aspect ratio.

2. The image processing apparatus according to claim 1,
wherein the image generation section compresses the pixel values with a higher compression ratio as they separate from a reference line parallel with a long side of the image shown by the pixel values.

3. The image processing apparatus according to claim 2,
wherein the image generation section generates the compressed image by removing a part of the pixel values.

4. The image processing apparatus according to claim 2,
wherein the pixel values are digital signals.

5. The image processing apparatus according to claim 4,
wherein the image generation section generates the compressed image based on the pixel values of a part corresponding to a position of the reference line.

6. The image processing apparatus according to claim 4,
wherein the image generation section sets a position of the reference line based on the pixel values.

7. The image processing apparatus according to claim 2,
wherein the pixel values are analog signals.

8. The image processing apparatus according to claim 7,
wherein, after the pixel values have been compressed, the image generation section generates the compressed image by removing both ends of a short side direction from the image shown by the compressed pixel values.

9. The image processing apparatus according to claim 7,
wherein the reference line passes through a center of the image shown by the pixel values.

10. The image processing apparatus according to claim 1, further comprising:
a display section;
a posture detection section which detects a posture of the display section; and
a control section which controls whether or not the compressed image is to be generated by the image generation section in accordance with the posture of the display section detected by the posture detection section.

11. The image processing apparatus according to claim 1,
wherein the first aspect ratio is 4:3, and the second aspect ratio is 27:9.

12. A non-transitory computer-readable storage medium having a program stored therein, the program causing a computer to function as:
an image generation section which generates a compressed image with a second aspect ratio having a short side smaller than that of a first aspect ratio based on pixel values from an imaging section which performs imaging with the first aspect ratio.
